(19) United States
(12) Patent Application Publication
(10) Pub. No.: US 2008/0130606 A1
(43) Pub. Date: Jun. 5, 2008

(54) METHOD AND APPARATUS FOR OPTIMIZING MULTIPATH DETECTION IN A WCDMA/HSDPA COMMUNICATION SYSTEM

(76) Inventors: Li Fung Chang, Holmdel, NJ (US); Hendrik Johannes Conroy, San Diego, CA (US); Severine Catreus-Erceg, Cardiff, CA (US)

Correspondence Address: MCANDREWS HELD & MALLOY, LTD, 500 WEST MADISON STREET, SUITE 3400, CHICAGO, IL, 60661, US

(21) Appl. No.: 11/565,438

(22) Filed: Nov. 30, 2006

(51) Int. Cl. H04B 7/216

(52) U.S. Cl. 370/342

(57) ABSTRACT

Methods and systems for processing signals in a wireless communication system are disclosed. Aspects of the method may include calculating at a receiver, a plurality of energy values corresponding to a plurality of signal paths detected within a communication channel. At least one of the plurality of detected signal paths may be selected for processing based on a pre-defined threshold and a dynamic threshold, in order to achieve a desired probability of misdetection and a desired probability of false alarm. The probability of misdetection is a probability that a real signal path is missed, and the probability of false alarm is a probability of detecting a false signal path. A slot boundary, a frame boundary, and/or a scrambling code may be determined for signals communicated via said plurality of signal paths.

### CROSS-REFERENCE TO RELATED APPLICATIONS/INCORPORATION BY REFERENCE

This application makes reference to:

U.S. application Ser. No. ______ (Attorney Docket No 18010US01), filed on even date herewith.

The above state application is hereby incorporated herein by reference in its entirety.

### FIELD OF THE INVENTION

Certain embodiments of the invention relate to the processing of wireless communication signals. More specifically, certain embodiments of the invention relate to a method and apparatus for optimizing multipath detection in a WCDMA/HSDPA communication system.

### BACKGROUND OF THE INVENTION

Mobile communication has changed the way people communicate and mobile phones have been transformed from a luxury item to an essential part of every day life. The use of mobile phones today is generally dictated by social situations, rather than being hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third generation (3G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase downlink throughput and, in turn, offer advanced QoS capabilities and speeds that rival those delivered by cable modem and/or DSL service providers. In this regard, networks based on wideband CDMA (WCDMA) technology may make the delivery of data to end users a more feasible option for today's wireless carriers.

The General Packet Radio Service (GPRS) and Enhanced Data rates for GSM (EDGE) technologies may be utilized for enhancing the data throughput of present second generation (2G) systems such as GSM. The GSM technology may support data rates of up to 14.4 kilobits per second (Kbps), while the GPRS technology may support data rates of up to 115 Kbps by allowing up to 8 data time slots per time division multiple access (TDMA) frame. The GSM technology, by contrast, may allow one data time slot per TDMA frame. The EDGE technology may support data rates of up to 384 Kbps. The EDGE technology may utilizes 8 phase shift keying (8-PSK) modulation for providing higher data rates than those that may be achieved by GPRS technology. The GPRS and EDGE technologies may be referred to as “2.5G” technologies.

The UMTS technology with theoretical data rates as high as 2 Mbps, is an adaptation of the WCDMA 3G system by GSM. One reason for the high data rates that may be achieved by UMTS technology stems from the 5 MHz WCDMA channel bandwidths versus the 200 KHz GSM channel bandwidths. The HSDPA technology is an Internet protocol (IP) based service, oriented for data communications, which adapts WCDMA to support data transfer rates on the order of 10 megabits per second (Mbits/s). Developed by the 3G Partnership Project (3GPP) group, the HSDPA technology achieves higher data rates through a plurality of methods. For example, many transmission decisions may be made at the base station level, which is much closer to the user equipment as opposed to being made at a mobile switching center or office. These may include decisions about the scheduling of data to be transmitted, when data is to be retransmitted, and assessments about the quality of the transmission channel. The HSDPA technology utilizes variable coding rates and supports 16-level quadrature amplitude modulation (16-QAM) over a high-speed downlink shared channel (HS-DSCH), which permits a plurality of users to share an air interface channel

In some instances, HSDPA may provide a two-fold improvement in network capacity as well as data speeds up to five times (over 10 Mbit/s) higher than those in even the most advanced 3G networks. HSDPA may also shorten the roundtrip time between network and terminal, while reducing variances in downlink transmission delay. These performance advances may translate directly into improved network performance and higher subscriber satisfaction. Since HSDPA is an extension of the GSM family, it also builds directly on the economies of scale offered by the world's most popular mobile technology. HSDPA may offer breakthrough advances in WCDMA network packet data capacity, enhanced spectral and radio access networks (RAN) hardware efficiencies, and streamlined network implementations. Those improvements may directly translate into lower cost-per-bit, faster and more available services, and a network that is positioned to compete more effectively in the data-centric markets of the future.

The capacity, quality and cost/performance advantages of HSDPA yield measurable benefits for network operators, and, in turn, their subscribers. For operators, this backwards-compatible upgrade to current WCDMA networks is a logical and cost-efficient next step in network evolution. When deployed, HSDPA may co-exist on the same carrier as the current WCDMA Release 99 services, allowing operators to introduce greater capacity and higher data speeds into existing WCDMA networks. Operators may leverage this solution to support a considerably higher number of high data rate users on a single radio carrier. HSDPA makes true mass-market mobile IP multimedia possible and will drive the consumption of data-heavy services while at the same time reducing the cost-per-bit of service delivery, thus boosting both revenue and bottom-line network profits. For data-hungry mobile subscribers, the performance advantages of HSDPA may translate into shorter service response times, less delay and faster perceived connections. Users may also download packet-data over HSDPA while conducting a simultaneous speech call.

HSDPA may provide a number of significant performance improvements when compared to previous or alternative technologies. For example, HSDPA extends the WCDMA bit rates up to 10 Mbps, achieving higher theoretical peak rates with higher-order modulation (16-QAM) and with adaptive coding and modulation schemes. The maximum QPSK bit rate is 5.3 Mbit/s and 10.7 Mbit/s with 16-QAM. Theoretical bit rates of up to 14.4 Mbit/s may be achieved with no channel coding. The terminal capability classes range from 900 kbits/s to 1.8 Mbit/s with QPSK modulation and 3.6 Mbit/s and up with 16-QAM modulation. The highest capability class supports the maximum theoretical bit rate of 14.4 Mbit/s.

Implementing advanced wireless technologies, such as WCDMA and/or HSDPA, may still require overcoming some architectural hurdles because of the very high speed, and wide bandwidth data transfers that may be supported by such wireless technologies. For example, an HSDPA Category 8 supports 7.2 Mbit/s of peak data throughput rate. Furthermore, various antenna architectures, such as multiple-input multiple-output (MIMO) antenna architectures, as well as multipath processing receiver circuitry may be implemented within a handheld device to process the high speed HSDPA bitstream. However, the implementation of HSDPA-enabled devices that provide higher data rates and lower latency to users may result in increased power consumption, implementation complexity, mobile processor real estate, and ultimately, increased handheld device size.

However, the widespread deployment of multi-antenna systems in wireless communications, particularly in wireless handset devices, has been limited by the increased cost that results from increased size, complexity, and power consumption. Providing a separate RF chain for each transmit and receive antenna is a direct factor that increases the cost of multi-antenna systems. As the number of transmit and receive antennas increases, the system complexity, power consumption, and overall cost may increase. In addition, conventional methods of signal processing at the receiver side of a wireless communication system do not take into account outside interference as well as IPI resulting within a multipath fading environment. Furthermore, conventional methods of multipath detection may result in missing detection of an existent path within a communication channel and/or detecting a non-existent path. This poses problems for mobile system designs and applications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or apparatus for optimizing multipath detection in a WCDMA/HSDPA communication system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary diagram of slot formats for a primary synchronization channel (PSCH), a secondary synchronization channel (SSCH), and a common pilot channel (CPICH), in connection with an embodiment of the invention.

FIG. 2 is a block diagram of an exemplary wireless multipath profile detector system, in accordance with an embodiment of the invention.

FIG. 3 is a flow diagram illustrating exemplary steps for determining a final list of Nf paths for processing by a RAKE receiver, in accordance with an embodiment of the invention.

FIG. 4 is a flow diagram illustrating exemplary steps for processing wireless signals in a WCDMA/HSDPA communication system, in accordance with an embodiment of the invention.

FIG. 5 is a flow diagram illustrating exemplary steps for processing wireless signals in a WCDMA/HSDPA communication system, in accordance with an embodiment of the invention.

FIG. 6 is an exemplary diagram illustrating a WCDMA handset communicating with two WCDMA base stations, in accordance with an embodiment of the invention.

### DETAILED DESCRIPTION OF THE INVENTION

Certain embodiments of the invention may be found in a method and/or apparatus for optimizing multipath detection in a WCDMA/HSDPA communication system. Aspects of the method may include calculating at a receiver, a plurality of energy values corresponding to a plurality of signal paths detected within a communication channel. At least one of the plurality of detected signal paths may be selected for processing based on a pre-defined threshold and a dynamic threshold, in order to achieve a desired probability of misdetection and a desired probability of false alarm. The probability of misdetection is a probability that a real signal path is missed, and the probability of false alarm is a probability of detecting a false signal path. A slot boundary, a frame boundary, and/or a scrambling code may be determined for signals communicated via said plurality of signal paths. The plurality of energy values may be calculated based on the determined slot boundary, the frame boundary, and/or the scrambling code. The plurality of energy values may be ordered based on a corresponding magnitude value. The detected signal paths may be selected for processing based on the plurality of ordered energy values. A first one of the plurality of detected signal paths may be selected using only the pre-defined threshold. A second one of the plurality of detected signal paths may be selected using only the dynamic threshold. The dynamic threshold may be selected so that it may be equal to a maximum one of: the pre-defined threshold and a scaled energy value of a strongest path selected from the plurality of signal paths. The dynamic threshold may also equal a scaled energy value of a strongest path selected from the plurality of signal paths, and/or a scaled value of the pre-defined threshold.

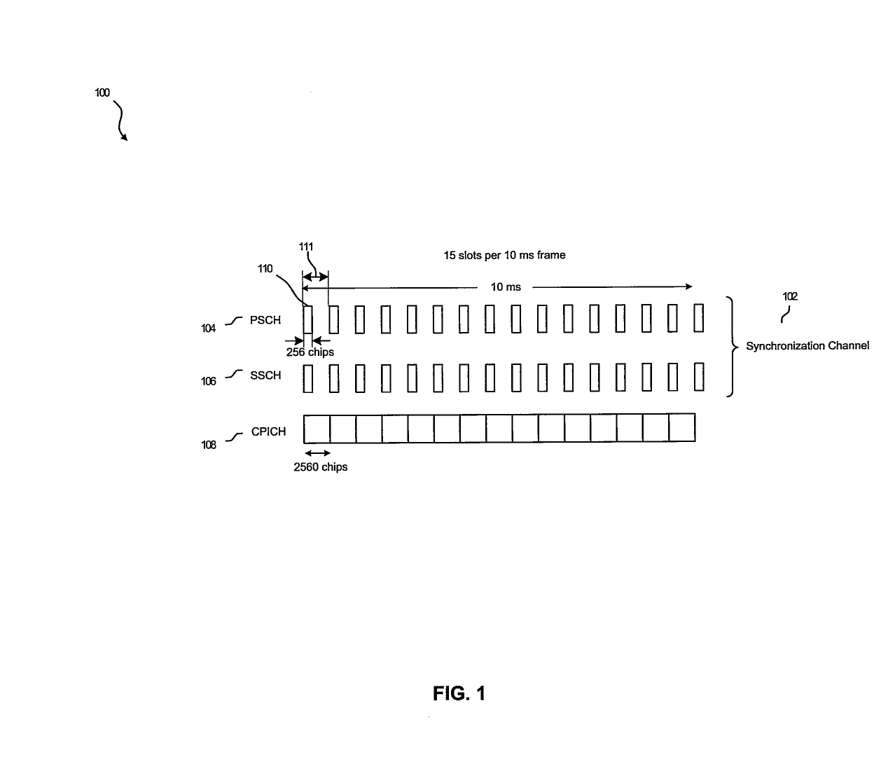

FIG. 1 illustrates an exemplary diagram of slot formats for a primary synchronization channel (PSCH), a secondary synchronization channel (SSCH), and a common pilot channel (CPICH), in connection with an embodiment of the invention. Referring to FIG. 1, the exemplary diagram 100 illustrates slot format for PSCH 104, SSCH 106 and CPICH 108.

In an exemplary WCDMA/HSDPA wireless system, a cell search procedure may be performed during initial acquisition when a wireless terminal or a mobile station (MS) is powered on, during idle mode so that the MS may locate a new cell to camp on, or during a handoff period for the MS to identify potential base stations for the call to be handed off to. In this regard, the WCDMA/HSDPA wireless system may utilize the synchronization channel (SCH) 102 and the common pilot channel (CPICH) 108 during a cell search by the MS. The SCH 102 may comprise a PSCH 104 and a SSCH 106.

Each 10 ms frame of 38400 chips may be divided into 15 slots, of 2560 chips each (0.67 ms). In this regard, the PSCH 104 and the SSCH 106 may comprise fifteen slots, such as slot 111, per 10 ms frame. The PSCH 104 and the SSCH 106 are each 256-chips (or one pilot symbol 110) long and may appear 1/10 of each time slot 111. The PSCH 104 and the SSCH 106 may be transmitted once in the same position in every slot. The PSCH 104 code may be the same for all time slots, and may be used to detect slot boundary and for slot synchronization to the strongest base station. The SSCH 106 may be used to identify a scrambling code group and frame boundary. The SSCH 106 sequences may vary from slot to slot and may be coded by a code book with 64 code-words, each representing a code-group. The CPICH 108 may carry pre-defined symbols with fixed rate, such as 30 kbps, with a spreading factor of 256. The channelization code for CPICH 108 may be fixed to the 0th code, for example. Furthermore, the CPICH 108 may be used to identify the scrambling code of the base station, after the scrambling code group is identified using the SSCH 106.

In this regard, the PSCH 104, the SSCH 106, and the CPICH 108 may be used to estimate the slot boundary, or the starting position of the strongest path, the scrambling code, and the frame boundary. The MS may then measure the multipath profile for the serving base station and generate a list of paths, which may be present in the communication channel. The generated list of paths may then be communicated to, for example, a RAKE finger management block for processing.

The accuracy of the content of the list of paths is important to the performance of the WCDMA/HSDPA system. In instances of “false alarm”, the list may comprise a “false” path, or a path that is detected while in reality it does not exist. The RAKE receiver may then assign a finger to such path that contains no signal and only contains noise, which may result in reducing the MS processing efficiency. In instances of missed detection, the list may omit a real path and, consequently, no finger may be assigned to the real path, which also reduces the MS processing efficiency.

In an exemplary embodiment of the invention, the list of detected paths within a communication channel may be generated by providing an optimized tradeoff between probability of missed detection and probability of false alarm. As used herein, the term “probability of missed detection” may be defined as the probability that a “real” path is missed, i.e. a path is present in the communication channel but it is not detected. As used herein, the term “probability of false alarm” may be defined as the probability of detecting a “false” path, i.e. a path is not present in the communication channel, but it is detected and present in the list of paths.

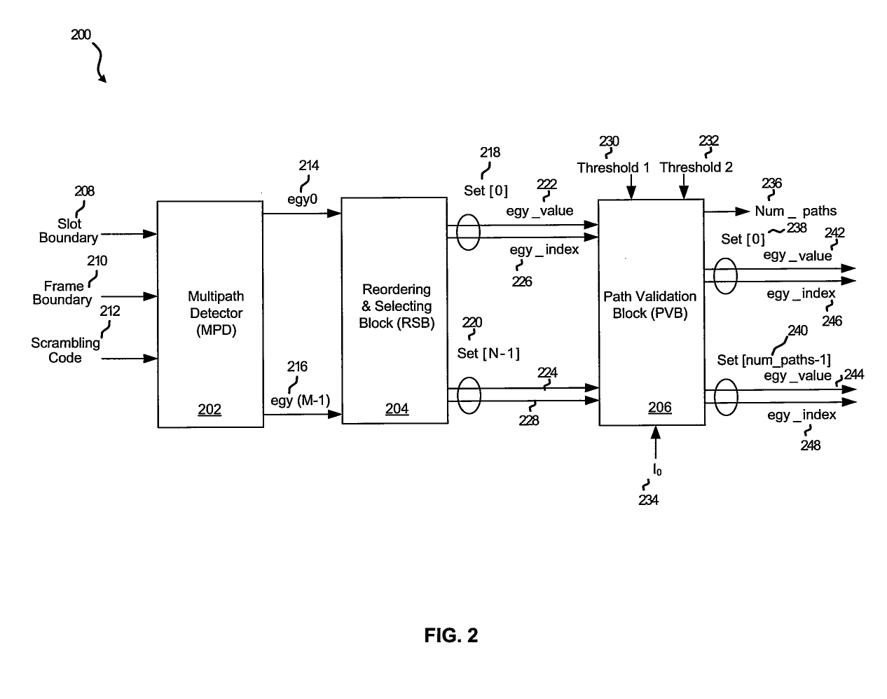

FIG. 2 is a block diagram of an exemplary wireless multipath profile detector system, in accordance with an embodiment of the invention. Referring to FIG. 2, the wireless detector system 200 may comprise a multipath detector block (MPD) 202, a reordering and selecting block (RSB) 204, and a path validation block (PVB) 206.

The MPD 202 may comprise suitable circuitry, logic and/or code and may be adapted to demodulate CPICH channel bits with delay equally spaced at, for example, 1 chip apart. In an exemplary embodiment of the invention, the MPD 202 may comprise a bank of M parallel correlators. The output of each correlator within the MPD 202 may be coherently accumulated over a given period of time, which may be defined in chips. The output may then be non-coherently accumulated, in a post-magnitude computation, over a second given period of time. After the coherent and non-coherent accumulations, the MPD 202 may output M measurements 214, . . . , 216 spaced 1 chip apart, each of which may correspond to an energy measured on the CPICH channel. The M energy measurements 214, . . . , 216 may be communicated to the RSB 204.

The RSB 204 may comprise suitable circuitry, logic and/or code and may be adapted to order or arrange the M energy measurements 214, . . . , 216 in a decreasing order, for example. The RSB 204 may then selects a subset of N (N≦M) largest measurements 218, . . . , 220 out of the total M measurements 214, . . . , 216. Each of the N selected measurements 218, . . . , 220 may be associated with a pair of parameters, such as energy index 226, . . . , 228, and energy value 222, . . . , 224. Each of the energy index values 226, . . . , 228 may be in the range of [0,M−1] and may indicate the path position in chips with respect to the start position (energy0). Each of the energy values 222, . . . , 224, corresponding to the measurements 218, . . . , 220, respectively, may be the result of the double accumulation performed by the MPD 202. After the RSB 204 generates the list of N measurements, the list may be communicated to the PVB 206 for further processing. The PVB 206 may comprise suitable circuitry, logic and/or code and may be adapted to validate the paths within a communication channel that correspond to the list of N measurements received from the RSB 204.

In operation, slot boundary information 208, frame boundary information 210, and scrambling code information 212 may be communicated to the MPD 202. The MPD 202 may demodulate CPICH channel bits with delay equally spaced at, for example, 1 chip apart. After the coherent and non-coherent accumulations, the MPD 202 may communicate the M measurements 214, . . . , 216 to the RSB 204. The RSB 204 may arrange the M energy measurements 214, . . . , 216 in a decreasing order, for example. The RSB 204 may then select a subset of N (N≦M) largest measurements 218, . . . , 220 out of the total M measurements 214, . . . , 216. Each of the N selected measurements 218, . . . , 220 may be associated with a pair of parameters, such as energy indices 226, . . . , 228, and energy values 222, . . . , 224. In this regard, the first measurement 218 may be characterized with a highest corresponding energy value 222. After the RSB 204 generates the list of N measurements, the list may be communicated to the PVB 206 for further processing.

The PVB 206 may be adapted to determine if a path is valid by comparing its position or index to other paths, and/or by comparing its energy value to one or more threshold values, such as threshold 1 230 and threshold 2 232. The PVB may also utilize the parameter Io 234, which may correspond to the total received power spectral density, including signal and interference, as measured at an antenna connector of a mobile station. The PVB 206 may generate an output 236 representing the total number of the validated paths, as well as a list of up to Nf paths 238, . . . , 240, where Nf may correspond to the number of fingers in the Rake. Furthermore, each of the Nf paths 238, . . . , 240 may comprise a corresponding index value 246, . . . , 248, and a corresponding energy value 242, . . . , 244, which may all be communicated to a RAKE receiver for further processing.

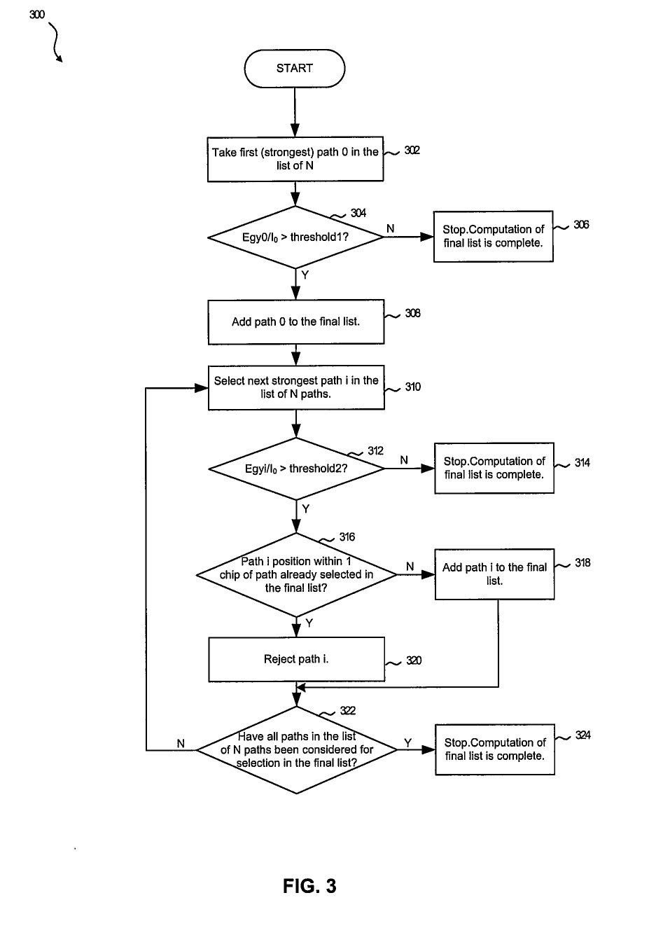

FIG. 3 is a flow diagram illustrating exemplary steps for determining a final list of Nf paths for processing by a RAKE receiver, in accordance with an embodiment of the invention. Referring to FIGS. 2 and 3, at 302, the first, strongest path 218 generated by the RSB 204, may be considered first for the final selection list of Nf paths generated by the PVB 206. The corresponding energy value egy0 222 may be normalized or divided by the Io measurement 234. At 304, it may be determined whether the ratio egy0/Io is greater than the first threshold 230. If the ratio egy0/Io is smaller than the first threshold 230, then at 306, the search for final selection may stop and the final list of Nf paths is empty. If the ratio egy0/Io is greater than the first threshold 230, at 308, path0 218 may be added to the final list of Nf paths. The search may then continue, at 310, with selection of the next strongest path in the list of N paths 218, . . . , 220. Its corresponding energy value egyi may then be normalized or divided by the Io measurement 234.

At 312, it may be determined whether the ratio egyi/Io is greater than the second threshold 232. If the ratio egyi/Io is not greater than the second threshold 232, then at 314, the search for final selection may stop and the final list of Nf paths is complete. If the ratio egyi/Io is greater than the second threshold 232, at 316, the position of path i may be compared to the position of the paths already selected in the final list. If the position is within 1 chip of position of paths already selected in the final list, the path may be rejected at 320. Otherwise, at 318, the path may be added to the final list. The search for final selection may continue until all paths present in the list of N paths 218, . . . , 220 have been considered for selection in the final list, or if the number of paths in the final list reaches Nf. At 322, it may be determined whether all the N paths 218, . . . , 220 have been considered for selection in the final list. If all the paths have been considered, at 324, the computation of the list is complete. If not, calculations may resume at step 310.

Referring again to FIG. 2, the selection of the second threshold 232 (threshold2) with respect to the first threshold 230 (threshold1) may affect the probability of missed detection and the probability of false alarm within the wireless detection system 200.

In a first embodiment of the invention, threshold2 may be calculated according to the following equation:

threshold2=max(threshold1,egy0/X).

In this regard, threshold2 may be selected as the maximum between threshold1 and the ratio of egy0 222 and X, where X may be a value that is selected arbitrarily. For example, X may be selected as X=10. In this case, if egy0/10>threshold1, the energy of subsequent paths, or paths following the strongest paths in the list of N paths 218, . . . , 220, may be compared to egy0/10. Any subsequent path may then be selected in the final list of Nf paths if its corresponding energy value is at least 1/10th of the energy of the strongest path. In other words, the energy of the path candidate may be compared to a portion of the energy of the strongest path, rather than to an absolute threshold. Consequently, if the strongest path comprises a large energy value, one or more of the subsequent paths may require a relatively large value as well to be selected in the final list. However, if the strongest path comprises a small energy value, the energy of the subsequent paths may be compared to an absolute threshold, such as thresholds to be selected in the final list. This embodiment may be used, for example, in instances when a low probability of false alarm may be desired. However, there may be instances when this embodiment may yield a high probability of missed detection.

In a second embodiment of the invention, threshold2 may be calculated according to the following equation:

threshold2=egy0/X.

In this regard, the energy of a subsequent path may be compared to a portion of the energy of the strongest path, regardless of the energy value egy0 of the strongest path. If the energy value of the strongest path is low, then the probability of missed detection is low but the probability of false alarm may be high. If the energy value of the strongest path is high, then the probability of missed detection may be high but the probability of false alarm may be low. This embodiment may be used in instances when a low probability of missed detection may be desired, at the cost of a higher probability of false alarm.

In a third embodiment of the invention, threshold2 may be calculated according to the following equation:

threshold2=threshold1/Y.

In this regard, the energy of any subsequent path may be compared to a portion of the absolute threshold, thresholds, where Y may be a value that is selected arbitrarily. For example, Y may be selected as Y=1. If the value of threshold1 is low, then the probability of missed detection may be low and the probability of false alarm may be high. If the value of threshold1 is high, then the probability of missed detection may be high and the probability of false alarm may be low. This embodiment may be used in instances when a low probability of missed detection may be desired, at the cost of a higher probability of false alarm.

In a fourth embodiment of the invention, threshold2 may be calculated according to a combination of at least two of the three embodiments disclosed above. For example, in instances when priority is placed on low probability of false alarm, the first embodiment may be used to determine threshold2. Such instances when priority is placed on low probability of false alarm may be, for example, during an initial cell search, before frequency lock is acquired. The first embodiment for determining threshold2 may also be utilized when measuring paths occurring before the strongest path to avoid, for example, disruption of timing reports estimated based on the first in time path.

In other instances, priority may be placed on low probability of missed detection. Such instances may include, for example, once frequency lock is acquired when measuring main path and any paths occurring later in time than main path. Under this condition, threshold2 may be set according to, for example, the third embodiment disclosed above.

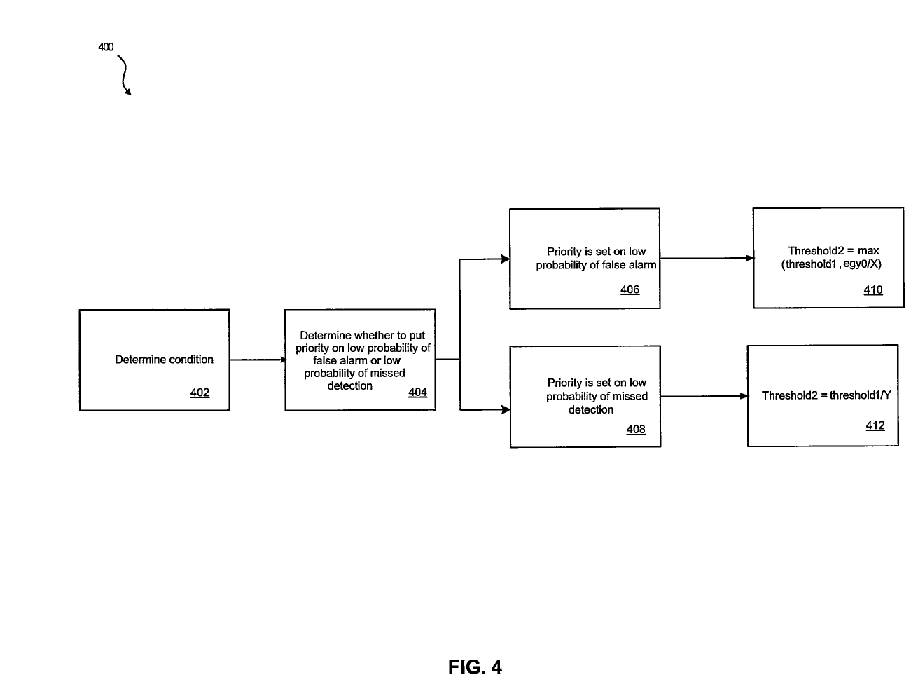

FIG. 4 is a flow diagram illustrating exemplary steps for processing wireless signals in a WCDMA/HSDPA communication system, in accordance with an embodiment of the invention. Referring to FIG. 4, at 402, a processing condition may be determined, which may require a determination of placing priority on a low probability of false alarm or a low probability of missed detection. At 404, it may be determined whether to place priority on a low probability of false alarm or a low probability of missed detection. At 406, priority may be set on a low probability of false alarm. In such instances, at 410, threshold2 may be calculated according to the first embodiment disclosed above, by using the following equation:

threshold2=max(threshold1,egy0/X).

At 408, priority may be placed on a low probability of missed detection. In such instances, at 412, threshold2 may be calculated according to the third embodiment disclosed above, by using the following equation:

threshold2=threshold1/Y.

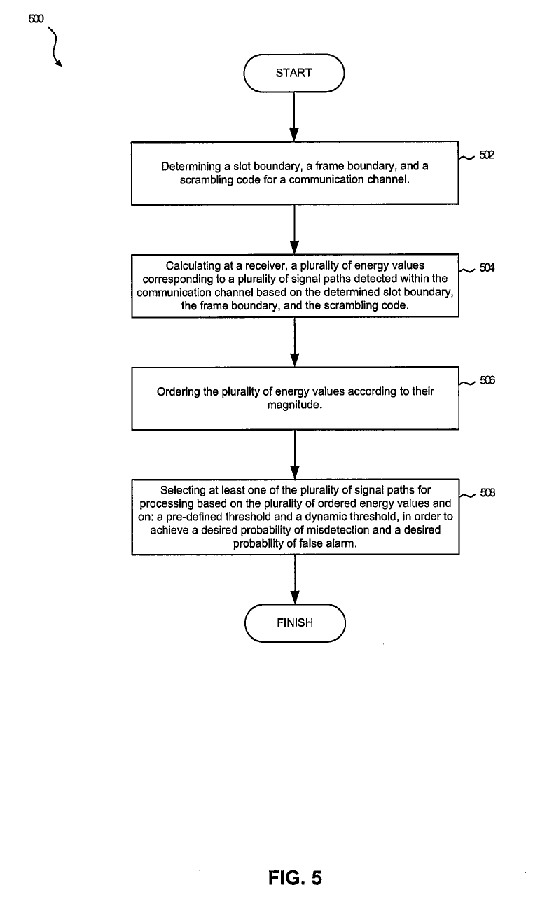

FIG. 5 is a flow diagram illustrating exemplary steps for processing wireless signals in a WCDMA/HSDPA communication system, in accordance with an embodiment of the invention. Referring to FIGS. 2 and 5, at 502, a slot boundary 208, a frame boundary 210, and a scrambling code 212 may be determined for signals communicated via said plurality of signal paths. At 504, a plurality of energy values 214, . . . , 216 corresponding to a plurality of signal paths detected within the communication channel may be calculated by the wireless system 200 based on the determined slot boundary 208, the frame boundary 210, and the scrambling code 212. At 506, the RSB 204 may order the plurality of energy values 214, . . . , 216 according to their magnitude, and may generate a list of N paths 218, . . . , 220, ordered according to magnitude. At 508, the PVB 206 may select at least one of the plurality of signal paths 218, . . . , 220 for processing based on the plurality of ordered energy values 222, . . . , 224 and on the pre-defined threshold 230 and the dynamic threshold 232, in order to achieve a desired probability of misdetection and a desired probability of false alarm.

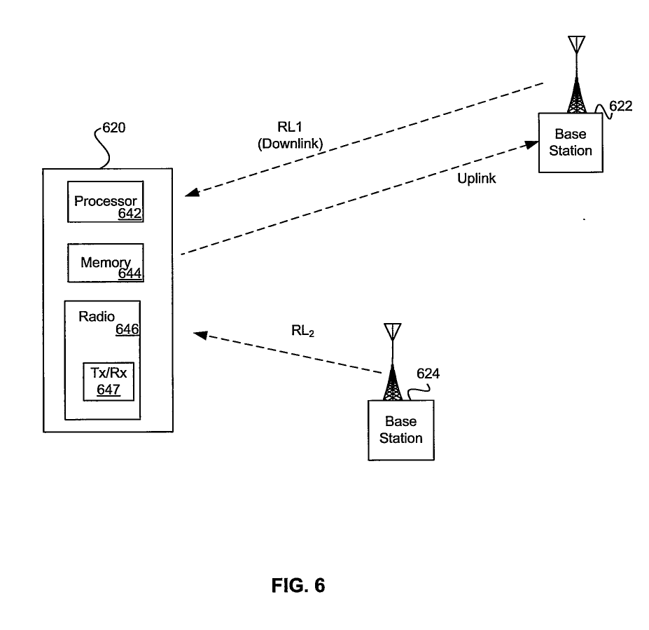

FIG. 6 is an exemplary diagram illustrating a WCDMA handset communicating with two WCDMA base stations, in accordance with an embodiment of the invention. Referring to FIG. 6, there is shown a mobile handset or user equipment 620, a plurality of base stations BS 622 and BS 624, and a plurality of radio links (RL), RL₁ and RL₂ coupling the user equipment (UE) 620 with the base stations BS 622 and BS 624, respectively. The user equipment 620 may comprise a processor 642, a memory 644, and a radio 646. The radio 646 may comprise a transceiver (Tx/Rx) 647.

In accordance with an embodiment of the invention, the processor 642 integrated within the UE 620, may enable calculation at the radio 646, of a plurality of energy values corresponding to a plurality of signal paths detected within a communication channel between the UE 620 and the BS 622 or 624. The processor 642 may enable selection of at least one of the plurality of detected signal paths for processing based on: a pre-defined threshold and a dynamic threshold, in order to achieve a desired probability of misdetection and a desired probability of false alarm. The probability of misdetection is a probability that a real signal path is missed, and the probability of false alarm is a probability of detecting a false signal path. The processor 642 may enable determination of a slot boundary, a frame boundary, and a scrambling code of signals communicated via the plurality of signal paths. The processor 642 may enable calculation of the plurality of energy values based on the determined slot boundary, the frame boundary, and the scrambling code of signals communicated via the plurality of signal paths.

The processor 642 may enable ordering of the plurality of energy values based on a magnitude of each of the plurality of energy values. The processor 642 may enable selection of the at least one of the detected signal paths for processing based on the plurality of ordered energy values. The processor 642 may enable selection of a first one of the plurality of detected signal paths using only the pre-defined threshold. The processor 642 may enable selection of at least a second one of the plurality of detected signal paths using only the dynamic threshold. The processor 642 may enable selection of the dynamic threshold so that the dynamic threshold is equal to a maximum one of the pre-defined threshold and/or a scaled energy value of a strongest path selected from the plurality of signal paths. The processor 642 may enable selection of the dynamic threshold so that the dynamic threshold is equal a scaled energy value of a strongest path selected from the plurality of signal paths. The processor 642 may enable selection of the dynamic threshold so that the dynamic threshold is equal a scaled value of the pre-defined threshold.

In an embodiment of the invention, a machine-readable storage may be provided, having stored thereon, a computer program having at least one code section executable by a machine, thereby causing the machine to perform the steps described herein for processing signals in a wireless communication system so as to improve multipath detection in a WCDMA/HSDPA communication system.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a wireless communication system, the method comprising:
calculating at a receiver, a plurality of energy values corresponding to a plurality of signal paths detected within a communication channel; and
selecting at least one of said plurality of detected signal paths for processing based on a pre-defined threshold and a dynamic threshold, in order to achieve a desired probability of misdetection and a desired probability of false alarm, wherein said probability of misdetection is a probability that a real signal path is missed and said probability of false alarm is a probability of detecting a false signal path.

2. The method according to claim 1, comprising determining a slot boundary, a frame boundary, and a scrambling code of signals communicated via said plurality of signal paths.

3. The method according to claim 2, comprising calculating said plurality of energy values based on said determined slot boundary, said frame boundary, and said scrambling code of signals communicated via said plurality of signal paths.

4. The method according to claim 1, comprising ordering said plurality of energy values based on a corresponding magnitude value of each of said plurality of energy values.

5. The method according to claim 4, comprising selecting said at least one of said detected signal paths for processing based on said plurality of ordered energy values.

6. The method according to claim 1, comprising selecting a first one of said plurality of detected signal paths using only said pre-defined threshold.

7. The method according to claim 1, comprising selecting at least a second one of said plurality of detected signal paths using only said dynamic threshold.

8. The method according to claim 1, comprising selecting said dynamic threshold so that said dynamic threshold is equal to a maximum value of one of: said pre-defined threshold and a scaled energy value of a strongest path selected from said plurality of signal paths.

9. The method according to claim 1, comprising selecting said dynamic threshold so that said dynamic threshold is equal to a scaled energy value of a strongest path selected from said plurality of signal paths.

10. The method according to claim 1, comprising selecting said dynamic threshold so that said dynamic threshold to equal to a scaled value of said pre-defined threshold.

11. A system for processing signals in a wireless communication system, the system comprising:
at least one processor integrated within a receiver that enables calculation at said receiver of a plurality of energy values corresponding to a plurality of signal paths detected within a communication channel; and
said at least one processor enables selection of at least one of said plurality of detected signal paths for processing based on a pre-defined threshold and a dynamic threshold, in order to achieve a desired probability of misdetection and a desired probability of false alarm, wherein said probability of misdetection is a probability that a real signal path is missed and said probability of false alarm is a probability of detecting a false signal path.

12. The system according to claim 11, wherein said at least one processor enables determination of a slot boundary, a frame boundary, and a scrambling code of signals communicated via said plurality of signal paths.

13. The system according to claim 12, wherein said at least one processor enables calculation of said plurality of energy values based on said determined slot boundary, said frame boundary, and said scrambling code of signals communicated via said plurality of signal paths.

14. The system according to claim 11, wherein said at least one processor enables ordering of said plurality of energy values based on a magnitude of each of said plurality of energy values.

15. The system according to claim 14, wherein said at least one processor enables selection of said at least one of said detected signal paths for processing based on said plurality of ordered energy values.

16. The system according to claim 11, wherein said at least one processor enables selection of a first one of said plurality of detected signal paths using only said pre-defined threshold.

17. The system according to claim 11, wherein said at least one processor enables selection of at least a second one of said plurality of detected signal paths using only said dynamic threshold.

18. The system according to claim 11, wherein said at least one processor enables selection of said dynamic threshold so that said dynamic threshold is equal to a maximum one of: said pre-defined threshold and a scaled energy value of a strongest path selected from said plurality of signal paths.

19. The system according to claim 11, wherein said at least one processor enables selection of said dynamic threshold so that said dynamic threshold is equal a scaled energy value of a strongest path selected from said plurality of signal paths.

20. The system according to claim 11, wherein said at least one processor enables selection of said dynamic threshold so that said dynamic threshold is equal a scaled value of said pre-defined threshold.
